(19) United States
(12) Patent Application Publication
(10) Pub. No.: US 2014/0375812 A1
(43) Pub. Date: Dec. 25, 2014

(54) Method for representing a vehicle's surrounding environment

(71) Applicant: ROBERT BOSCH GMBH, Stuttgart (DE)

(72) Inventors: Tobias Ehlgen, Ravensburg (DE); Leo Vepa, Ulm (DE)

(21) Appl. No.: 14/350,521

(22) PCT Filed: Sep. 24, 2012
(86) PCT No.: PCT/EP2012/068794

§ 371 Date: Apr. 8, 2014

(30) Foreign Application Priority Data
Oct. 14, 2011 (DE) 10 2011 084 554.2

(51) Int. Cl. B60R 11/04; H04N 7/18

(52) U.S. Cl. CPC B60R 11/04; H04N 7/181; B60R 2300/105
USPC 348/148

(57) ABSTRACT

A method for modifying a plane of projection in response to detection of at least one object, in particular, at least one raised object in the surroundings of a vehicle. The surroundings of the vehicle are monitored for raised objects. The coordinates of a base point of at least one detected, raised object and the width thereof are determined. The plane of projection is raised in front of the at least one detected, raised object, starting from the base point thereof, if indicated, within a transition region.

### FIELD OF THE INVENTION

The present invention relates to a method for representing a vehicle's surrounding environment on a human-machine interface in a driver assistance system. The present invention also relates to a corresponding computer program product, as well as a corresponding driver assistance system.

### BACKGROUND INFORMATION

Driver assistance systems are auxiliary devices in a vehicle whose purpose is to assist the driver in maneuvering the vehicle. Driver assistance systems typically encompass different subsystems, such as a park assist system, a navigational system or a blind spot warning system that employ a sensor system to monitor the vehicle's surrounding environment. Such sensor systems may include optical sensors, ultrasound sensors, radar sensors or LIDAR sensors, for example, which, individually or in combination, generate, respectively process data relating to the vehicle's surrounding environment.

European Patent Application EP 2 058 762 A2 discusses a method for directly representing distances of objects to a vehicle in a bird's-eye view. First, an image acquisition unit detects objects located in the surroundings of the vehicle. If an object is detected that is expected to collide with the vehicle at a specific height above ground, a virtual plane of projection is then created at the height of the collision point. In the course of the image processing, the pixels of the image recorded by the image acquisition unit are projected onto this plane, and an image is thus generated from the bird's eye perspective. In addition, pixels between the vehicle and the collision point are projected onto one plane at the level of the roadway, and more remote pixels are projected onto the virtual plane of projection.

The German Patent Application DE 10 2010 010 912 A1 relates to a driver assistance device having an optical representation of captured objects. The driver assistance device includes a sensor device for recording objects in the surroundings of the vehicle, as well as a display device. The sensor device can measure ground coordinates of the object as 2D or 3D positional data that the display device then uses in the perspective representation for positioning a symbol that symbolizes the object in the plan view. A symbol of the captured object is placed in the perspective representation. A plurality of recorded images around the vehicle are needed to be able to represent the entire surroundings of the virtual vehicle. These particular recorded images are preprocessed, and the information contained therein is used to produce a bird's eye perspective representation.

German Patent Application DE 10 2005 026 458 A1 relates to a driver assistance system for a vehicle. The driver assistance system includes an evaluation unit which, by analyzing sensor signals, determines distance data to objects captured at close range to the vehicle. The defined distance data are represented as an object contour on an optical display in relation to a schematic plan view of the particular vehicle.

Today's multi-camera systems, which are used in automobiles, compute a shared view from images from a plurality of cameras installed in the vehicle. Through the use of a virtual camera, different views can be represented by the plurality of cameras installed in the vehicle. This allows the driver to see the entire immediate surroundings of the vehicle simply by glancing at the heads-up display. Thus, using such a system, the driver can have an overview of blind spots.

### SUMMARY OF THE INVENTION

The method provided by the present invention makes it possible to detect objects projecting in the vicinity, i.e., in the surroundings of the vehicle, in the course of an image processing and/or on the basis of other sensor systems, thus, for example, laser, radar, lidar, ultrasound, stereo-camera systems, to name just a few. Instead of projecting these detected objects into the plane, the approach according to the present invention provides that the coordinates of the base point of the object be determined upon detection of a raised object. In a subsequent method step, the plane of projection is raised in front of the object, so that raised objects in the surroundings of the vehicle are no longer projected as “shadows cast” onto the plane, rather are discernible as raised objects in the various selectable views of the virtual camera. This procedure leads to an improved representation of the surroundings, respectively to a better processing of the ambient situation for the driver, within which he/she is able to better orient himself/herself since the image has a more natural appearance and a more intuitive aura.

If it is additionally possible to also determine the height of the object, then this is likewise considered in the modification of the plane of projection, making it possible to further improve the view.

The advantages of the present approach are evident above all in that raised objects are represented more naturally and intuitively by raising a plane of projection. As a result, the representation no longer has an artificial character, and the driver is provided with a more natural representation of his/her immediate surroundings.

The present invention is explained below in greater detail with reference to the drawings.

### BRIEF DESCRIPTION OF THE DRAWINGS

FIG. 1 shows four images from a plurality of cameras installed in the vehicle in a shared view.

FIG. 2 shows a two-dimensional plan view of a vehicle, including the camera, from the bird's eye perspective.

FIG. 3 shows an allround view of the vehicle from one angle of view.

FIG. 4 shows a plane of projection extending in front of a vehicle, including a horizontal and vertical portion.

FIG. 5 shows an adapted plane of projection, whose vertical region is located near the base point of a detected raised object.

FIG. 6 shows another adapted plane of projection whose vertical region extends out from the base point of the raised object and is adapted in the height thereof to the height of the detected, raised object.

### DETAILED DESCRIPTION

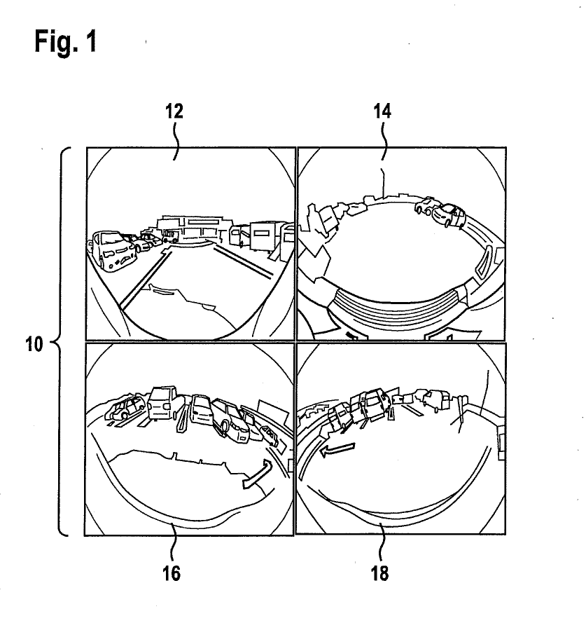

From the representation in accordance with FIG. 1, an overall view of four photos is readily apparent that is recorded by the cameras installed in the vehicle. A shared view may be generated from 1-4 camera images 12, 14, 16 and 18 that are captured by the cameras installed in the vehicle. Through the use of a virtual camera, different views may thereby be represented, allowing the driver to see the entire immediate surroundings of the vehicle simply by glancing at a heads-up display. This makes it possible for the driver, inter alia, to also have an overview of blind spots.

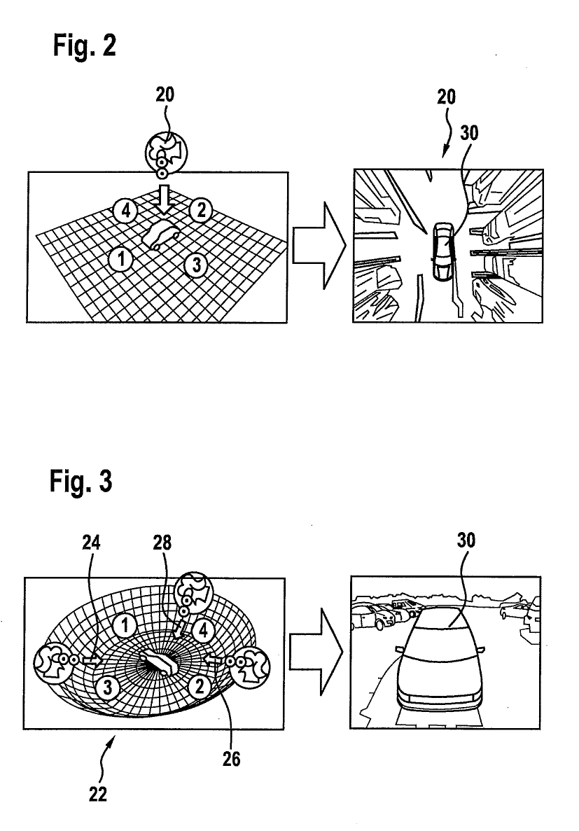

A bird's-eye perspective 20 is shown exemplarily in the representation in accordance with FIG. 2 in which a top view of vehicle 30 is provided.

From camera images 12, 14, 16, 18, a curved, allround display 22 in a three-dimensional view may also be created that images the surroundings of vehicle 30. Instead of projecting camera images 12, 14, 16 and 18 onto a plane, the individual images may be projected onto a cylindrically curved surface, making it possible to significantly improve the representation, particularly with regard to reproducing an area that is located further away.

### DETAILED DESCRIPTION

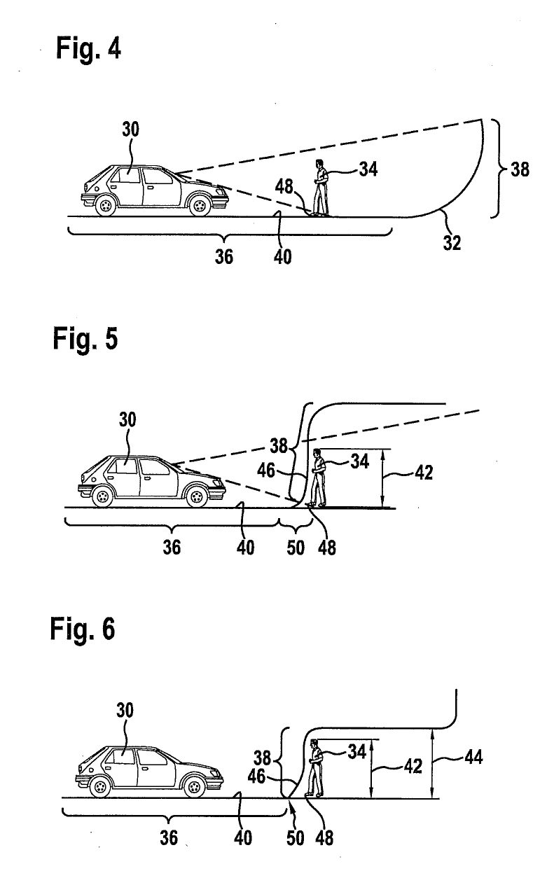

A plane of projection will become apparent from the representation in accordance with FIG. 4 that features a horizontal region extending in front of a vehicle and a perpendicular region extending vertically relative to the vehicle.

As the representation in accordance with FIG. 4 shows, vehicle 30 is located on a roadway 40 that represents horizontal region 36 of a plane of projection 46. FIG. 4 shows that at least one raised object 34, shown here as a person, is located in horizontal region 36 of plane of projection 46. FIG. 4 shows that plane of projection 46 starts from vehicle 30 and extends in vertical region 38 thereof behind the at least one detected, raised object 34. Therefore, the detected, at least one raised object 34 in plane of projection 46, in particular in vertical region 38, is represented unnaturally as a distorted cast shadow. As is readily apparent from FIG. 4, in this variant of an embodiment, vertical region 38 coincides with plane of projection 46 that is indicated by a broken line. Plane of projection 46 is predefined and is not intrinsically flexible.

It is readily apparent from the ray path plotted in FIG. 4 that raised object 34, shown here as a person, is represented by the ray that passes by the head, as well as the ray that passes the base point of raised object 34, including a considerable shear, indicated by the bottom arrow extending from the base point of raised object 34 to vertical curved region 38 of the plane of projection, i.e., is considerably distorted, in particular, as a shear.

In accordance with the illustration in FIG. 4, plane of projection 46 is a plane configured in a saucer shape upon which the video views of the vehicle's surrounding environment are projected. In this context, the transition between horizontal region 36 and vertical region 38 of saucer-shaped plane 32 may be selected in a way that allows it to coincide with the transition between flat regions, such as roadway 40, on which vehicle 30 is located, and raised objects, such as buildings, respectively people 34. In this manner, raised objects 34 in the surroundings of the vehicle, in particular on plane of projection 46, rather reflect reality and no longer convey the sometimes seemingly artificial impression thereof.

An adapted plane of projection, that extends in front of the vehicle, is readily apparent from the representation of FIG. 5.

As FIG. 5 shows, a raised object 34 in the form of a person is detected in the surrounding environment of vehicle 30. A base point 48 of raised, detected object 34 is now determined, from which the detected, at least one raised object 34, starting out from roadway 40, i.e., horizontal region 36 of plane of projection 46, rises up from the same. A comparison with FIG. 4 reveals that plane of projection 46 is adapted as a function of the determination of base point 48 in such a way that vertical region 38 of plane of projection 46 is optionally raised in front of base point 48 of raised object 34 within a transition region 50 in a way that allows the at least one detected, raised object 34 to be located in plane of projection 46, in particular in vertical region 38 thereof. The purpose of transition region 50 is to make possible a continuous transition of the plane of projection, in particular, a continuous transition between horizontal region 36 and vertical region 39 of plane of projection 46.

To complete this description, it is noted that, in the representation in accordance with FIG. 5, vertical region 38 exceeds actual height 42 of raised object 34, in this case, the body height of the raised object of person 34.

The transition point where horizontal region 36 of plane of projection 46 transitions into vertical region 38 essentially coincides with base point 48 of the at least one detected, raised object 34.

Another adaptation of the plane of projection, in particular in consideration of the size of the at least one detected, raised object, is inferable from the representation in accordance with FIG. 6.

As FIG. 6 shows, an estimated height 44 is marked in this illustration, that essentially corresponds to height 42, in the present case, to the body height of the person representing the at least one raised object. It is self-evident that, if raised object 34 is not a person, height 42 relates to a different object. The at least one raised object 34 may be perceived by the driver of vehicle 30 as being located in the plane of projection, in particular in vertical region 38 of plane of projection 46, and be shown as a natural object in a heads-up display, for example. The result is a substantially improved representation of the surroundings for the driver of vehicle 30 in which he/she is able to better orient himself/herself since the image of the at least one raised object 34 located in plane of projection 46, in particular in vertical region 38 thereof, has a substantially more natural appearance, and the representation of raised object 34, for example in a heads-up display, loses the artificial character thereof.

If, as indicated in FIG. 6, the height of vertical portion 38 is adapted to actual height 42 of the at least one detected, raised object 34, the representation of objects 34 may be improved once more.

As is indicated in connection with FIG. 4, plane of projection 46 initially has a saucer-shaped appearance. Upon detection of an object, plane of projection 46 having a saucer-shaped configuration is dented, i.e., the height and width, as well as a base point of an object 34 are estimated. Since an object 34 is now localized, plane of projection 46 may be modified. In the present example in accordance with FIG. 5, given a fixed implementation, plane of projection 46 is raised earlier than in the representation in accordance with FIG. 4, i.e., with respect to the location thereof in the plane of raised object 34. This raising of plane of projection 46 is implemented over the width of raised object 34.

In addition, in the representation in accordance with FIG. 6, a change in plane of projection 46 is ensured by height 42 of raised object 34, in addition to the width thereof.

With regard to the sensor systems that are used in the present context for implementing the inventive method, most notably, ultrasound sensors, radar sensors, laser sensors, stereo cameras, as well as Structure from motion systems, a mono-camera and the like are suited. Using such sensor systems that capture the surrounding environment of vehicle 30, it is possible to record the measured values of raised object 34. The recorded measured values may be converted into a position relative to any given desired coordinate system, for example.

In connection with FIG. 1 through 3, it is noted that a real camera is not used to combine the image sequence of camera images 12, 14, 16, 18 in a bird's-eye perspective, for example. Rather, captured camera images 12, 14, 16 and 18 undergo an image transformation, so that the transformed image has the appearance of having been captured by a real camera located above vehicle 30. In the present context, “virtual camera” is understood to be one that would provide a transformed image of camera images 12, 14, 16 and 18 captured by real cameras.

The present invention is not limited to the exemplary embodiments described here and the aspects emphasized therein. Rather, within the subject matter indicated by the pending claims, a multiplicity of modifications are possible that reside within the scope of expert activity.

1-9. (canceled)

10. A method for representing a vehicle's surrounding environment in an all-round view, the method comprising:
recording images, with camera systems of a vehicle;
projecting the recording images as transformed images onto a configured plane of projection; and
in response to detection of a raised object, in the surroundings of the vehicle, modifying the configured plane of projection by performing the following:
detecting a raised object in the surroundings of the vehicle;
determining coordinates of the raised object, including a base point of the raised object in the configured plane of projection and the width thereof and
adaptating the configured plane of projection so that the configured plane of projection is raised over the width of the raised object in front of the raised object, essentially near the ascertained base point thereof.

11. The method of claim 10, wherein the configured plane of projection is formed by a horizontal region located in front of the vehicle and by a vertical region located at a greater distance from the vehicle.

12. The method of claim 10, wherein, in response to detection of at least one raised object, a transition of the horizontal region into the vertical region of the configured plane of projection is shifted into the vicinity of the base point of the at least one detected, raised object.

13. The method of claim 10, wherein, starting out from the base point of the raised, detected object, the configured plane of projection is adapted in width in conformance with the width of the raised object.

14. The method of claim 10, wherein, as a function of a height of the at least one detected, raised object, a height of the vertical region is adapted in the width of the raised object to the configured projection plane.

15. The method of claim 10, wherein the detected raised object is imaged in the adapted plane of projection as a 3D representation.

16. The method of claim 10, wherein, in the configured plane of projection, a transition region is provided within which the horizontal region transitions into the vertical region.

17. A computer readable medium having a computer program, which is executable by a processor, comprising:
a program code arrangement having program code for representing a vehicle's surrounding environment in an all-round view, by performing the following:
recording images, with camera systems of a vehicle;
projecting the recording images as transformed images onto a configured plane of projection; and
in response to detection of a raised object, in the surroundings of the vehicle, modifying the configured plane of projection by performing the following:
detecting a raised object in the surroundings of the vehicle;
determining coordinates of the raised object, including a base point of the raised object in the configured plane of projection and the width thereof; and
adaptating the configured plane of projection so that the configured plane of projection is raised over the width of the raised object in front of the raised object, essentially near the ascertained base point thereof.

18. A driver assistance system for a driver of a vehicle, comprising:
sensor systems for detecting raised objects in surroundings of the vehicle;
components for determining coordinates of a base point of at least one detected, raised object and the width thereof; and
a component for raising a configured plane of projection near the raised object, essentially near the ascertained base point thereof over the width of the at least one detected, raised object.
